(19) United States
(12) Patent Application Publication
(10) Pub. No.: US 2015/0025688 A1
(43) Pub. Date: Jan. 22, 2015

(54) CONTROL UNIT FOR FURNITURE ADJUSTMENT DRIVES AND AUXILIARY DEVICE FOR A CONTROL UNIT

(71) Applicant: DEWERTOKIN GMBH, Kirchlengern (DE)

(72) Inventors: Armin Hille, Bielefeld (DE); Steffen Loley, Osnabrück (DE); Thomas Schröder, Kirchlengern (DE)

(73) Assignee: DEWERTOKIN GMBH, Kirchlengern (DE)

(21) Appl. No.: 14/381,877

(22) PCT Filed: Feb. 28, 2013
(86) PCT No.: PCT/EP2013/054097

§ 371 Date: Aug. 28, 2014

(30) Foreign Application Priority Data
Feb. 28, 2012 (DE) 10 2012 101 626.7

(51) Int. Cl. G05B 15/02; G05F 1/66

(52) U.S. Cl. CPC G05B 15/02; G05F 1/66
USPC 700/275

(57) ABSTRACT

The invention relates to a control device (9) for at least one electromotive adjusting drive (7, 8) of a piece of furniture (1), comprising at, least one adjusting drive connection (91) for connecting to the at least one electromotive adjusting drive (7, 8), and an interface (92) for coupling to at least one operating unit (10). When a control element (12, 13) of the control unit is actuated, a switch signal is emitted at the end of the control for controlling the at least electromotive adjusting drive (7, 8) and/or an electric motor of the electromotive adjusting drive (7, 8). Said control device is characterised in that it comprises a multi-functional connection (93) designed as a multi-functional interface, said connection comprising at least one data signal line for transferring data, at least one power supply line and at least one signal input and output line. Said control device (9) is designed to emit data signals on the data signal line of the multi-functional interface, in accordance with the actuation of one of the operating elements (12, 13) or additional operating elements (15, 16, 17) of the operating unit (10). The invention also relates to an additional device for joining to a control device, to a system comprising a control device and a piece of furniture equipped therewith.

The invention relates to a control unit for at least one electromotive adjustment drive to be arranged in a piece of furniture, having at least one adjustment drive terminal for connection to the at least one electromotive adjustment drive and an interface for coupling to at least one operating unit, wherein, upon actuation of an operating element of the operating unit, a switching signal is output at the terminal to activate the at least one electromotive adjustment drive or an electric motor of the electromotive adjustment drive. The invention furthermore relates to an auxiliary device for connection to a control unit, a system having a control unit, and a piece of furniture equipped therewith.

Adjustment drives, frequently also referred to as electromotive furniture drives, are installed in lounging furniture and seating furniture, to be able to move comfortably an adjustment of furniture parts such as seats, backrests, foot rests, etc. in relation to a main body of the furniture and in relation to one another. Adjustable seating furniture, in particular so-called television or relaxation chairs, typically have for this purpose a furniture fitting which is relatively mechanically complex, and which, in cooperation with a plurality of levers and linkages, enables a complex movement sequence of the various cushion units installed thereon.

For the activation and power supply of the adjustment drives, a control unit is arranged on or in the piece of furniture, which receives operating commands of a user from an operating unit and converts them into activation signals for the adjustment drives.

Such a control unit and operating unit is known, for example, from document DE 10 2008 033 627 A1. A control unit is known in document DE 93 16 465 U1, which, in addition to the activation of adjustment drives, has further functionalities. An emergency lowering function and a control by a timer are thus integrated. It is disadvantageous in this case that for different desired further functionalities, a corresponding control unit must be prepared as an independent product in each case, which increases development, production, and warehousing costs.

It is the object of the present invention to provide an adaptation-capable control unit, which can be supplemented easily with desired auxiliary functions.

The object is achieved by a control unit and an auxiliary device having the respective features of the independent claims. The object is furthermore achieved by a system made of such a control unit and such an auxiliary device, and also a piece of furniture equipped therewith. Preferred refinements are the subject matter of the dependent claims.

A control unit according to the invention of the type mentioned at the outset has a multifunction terminal implemented as a multifunction interface, which has at least one data signal line for data transmission, at least one power supply line, and at least one input signal line and one output signal line. In this case, the control unit is configured for the purpose of outputting, on the data signal line of the multifunction interface, data signals in dependence on an actuation of one of the operating elements or further operating elements of the operating unit. Such a multifunction interface enables auxiliary devices to be connected, which then interact with the control unit and can also be operated via the operating unit, in that the data signals transmitted via the data signal line or the output signal line are analyzed. The data signal lines are preferably designed in this case for serial data transmission. Alternatively, parallel data transmission is possible. The system can be expanded flexibly by the multifunction interface and is therefore producible in a material-effective and cost-effective manner in a basic version and is nonetheless adaptable if needed.

In an advantageous embodiment of the control unit, voltage is applied to the at least one output signal line by the control unit in dependence on an actuation of one of the operating elements or further operating elements of the operating unit. Auxiliary devices can thus offer at least specific functionalities, without themselves requiring a logic circuit, for example, a bus interface, to analyze signals on the data signal lines. The at least one output signal line is preferably configured to activate an illuminant. The frequently requested auxiliary functionality of a light can thus be implemented very easily and using a cost-effective auxiliary device.

In an advantageous embodiment of the control unit, a signal on the at least one input signal line is input and analyzed by the control unit. This is also used for the purpose of being able to implement frequently required auxiliary functionalities easily in auxiliary devices. The signal on the at least one input signal line preferably relates to emergency lowering of the at least one adjustment drive, wherein the control unit is configured for the purpose of actuating the at least one adjustment drive independently of an actuation of an operating element of the operating unit. This safety-critical function can thus be implemented without analyzing signals on the data signal lines. This is not only cost-effective, but rather also preferable with regard to safety technology in relation to a signal transmission for emergency lowering via the data signal lines. The multifunction terminal particularly preferably has, in addition to the power supply line, an emergency power supply line, which can be used in this context if the regular power supply is not available.

An auxiliary device according to the invention for connection to such a control unit has a multifunction cable having multifunction plug for connection to the multifunction terminal of the control unit, whereby the multifunction interface is available in the auxiliary device. Using an auxiliary device compatible in this manner with the control unit, the advantages of the multifunction interface can be used for the auxiliary device.

In an advantageous embodiment, the auxiliary device has a multifunction terminal having an electrical connection to the multifunction cable. Multiple auxiliary devices can thus be connected chained in succession (daisy-chained), also if the control unit only has one multifunction terminal.

In a further advantageous embodiment, the auxiliary device is implemented as a lighting unit and has an illuminant, which is supplied with power and/or activated via one of the output signal lines of the multifunction interface. In an advantageous embodiment, the auxiliary device is implemented as an emergency lowering unit and has an emergency switch, which interacts with one of the input signal lines of the multifunction interface. A battery receptacle for at least one battery is particularly preferably provided in this case and the emergency lowering unit is configured for the purpose of applying a voltage of the at least one battery to an emergency power supply line of the multifunction interface upon actuation of the emergency switch. The mentioned auxiliary functions are thus available in the system in a manner that can be retrofitted.

In a further advantageous embodiment, the auxiliary device is implemented as a USB terminal unit and has at least one USB terminal, which is connected to power supply lines and/or data signal lines of the multifunction interface. In addition, an audio terminal is preferably provided for relaying an audio signal via an audio cable. In addition, a Bluetooth interface can also be provided for coupling to a smart phone, inter alia. Such an auxiliary device expands the control unit with multimedia functionalities and in practical use provides a charging capability for multimedia and telephone devices. This thus prevents excessively many cables of charging devices from lying around the piece of furniture, from which a tripping hazard originates.

In a further advantageous embodiment, the auxiliary device is implemented as a multifunction radio device and has a radio and optionally a clock. Functionalities of the above-mentioned auxiliary device can preferably also be integrated here.

In a further advantageous embodiment, the auxiliary device has a network power socket, which is switchable via data signals on the data signal line of the multifunction interface. Further consumers or devices can thus be controlled.

A system according to the invention for controlling at least one adjustment drive of a piece of furniture comprises an above-described control unit, which is connected to the adjustment drive, and at least one above-described auxiliary device. A piece of furniture according to the invention having a frame element and a support element, which is guided movably in the frame element via at least one adjustment drive, comprises such a system. The advantages mentioned in conjunction with the control unit and the auxiliary device result.

The invention will be explained in greater detail hereafter on the basis of exemplary embodiments with the aid of the appended drawings. In the figures:

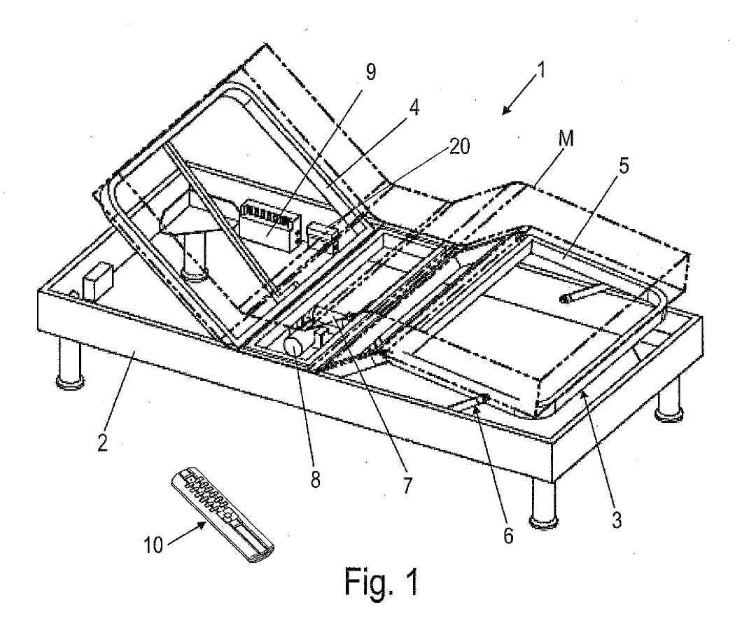

FIG. 1 shows a schematic perspective view of an exemplary furniture assembly;

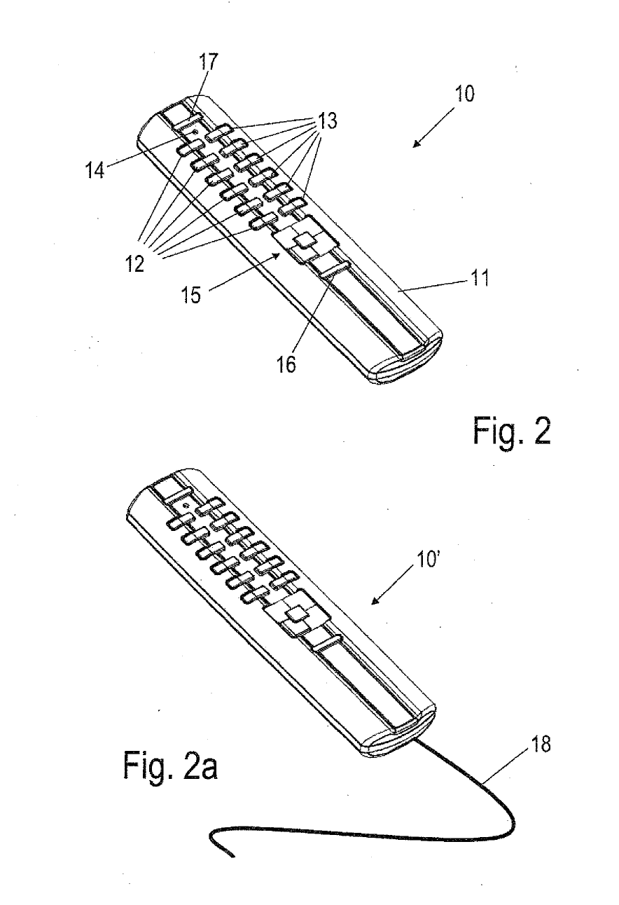

FIGS. 2-2a show schematic perspective views of an operating unit;

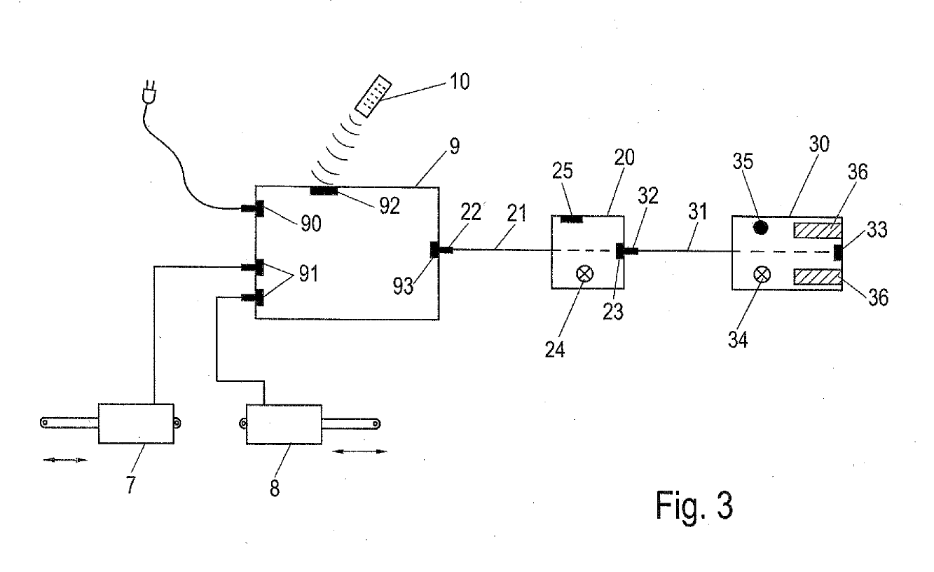

FIG. 3 shows a block diagram of a system made of control unit, adjustment drives, and auxiliary devices;

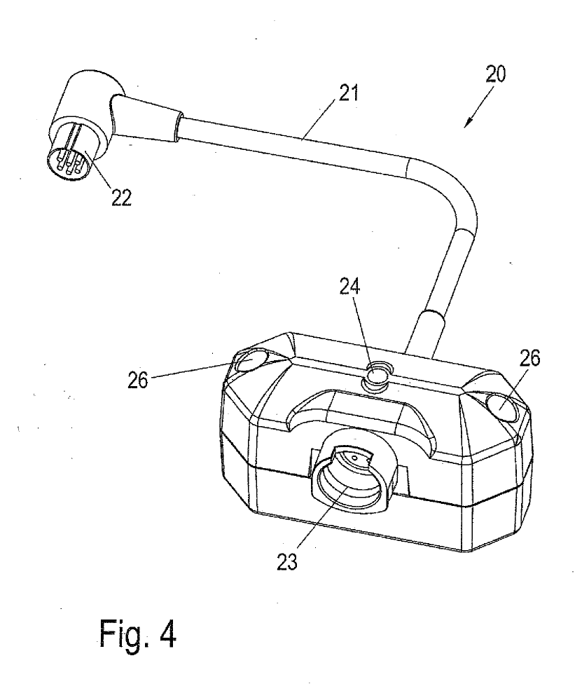

FIG. 4 shows a schematic perspective view of a lighting unit as a first exemplary embodiment of an auxiliary device;

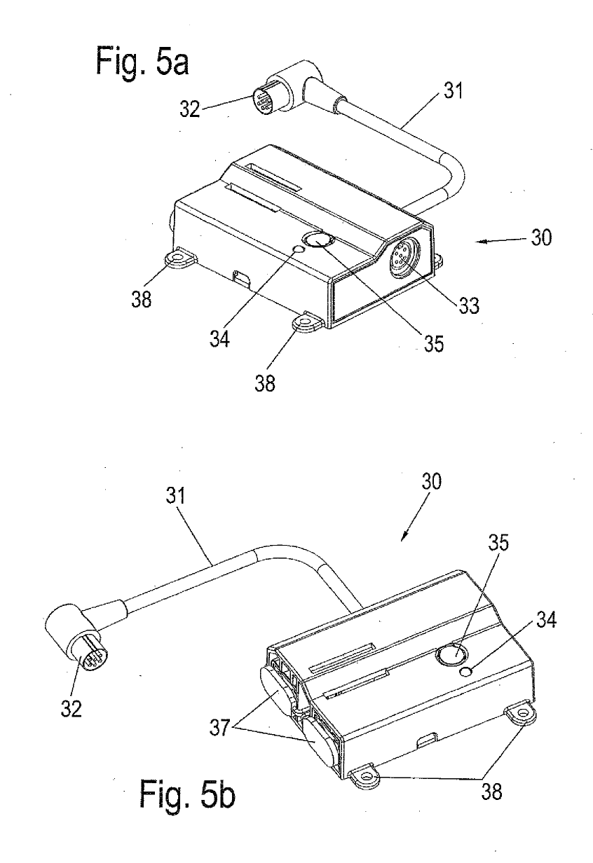

FIGS. 5a, 5b show a schematic perspective view of an emergency lowering unit as a second exemplary embodiment of an auxiliary device;

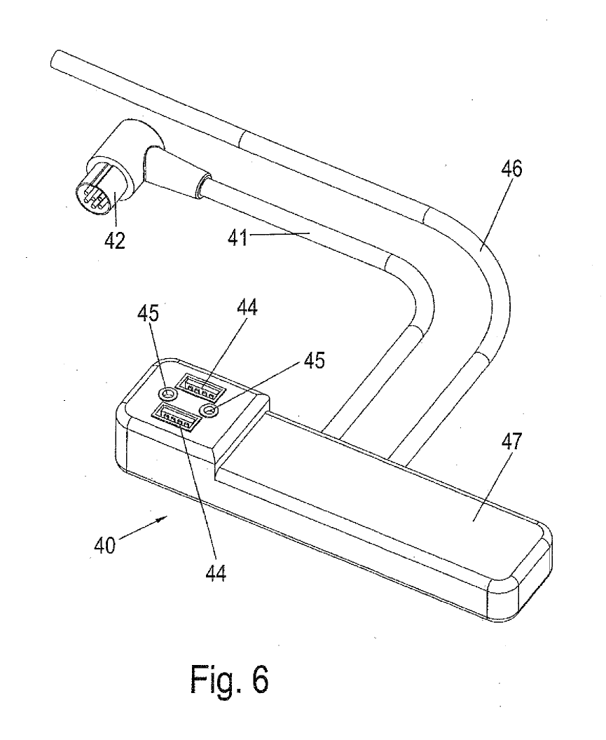

FIG. 6 shows a schematic perspective view of a USB terminal unit as a third exemplary embodiment of an auxiliary device; and

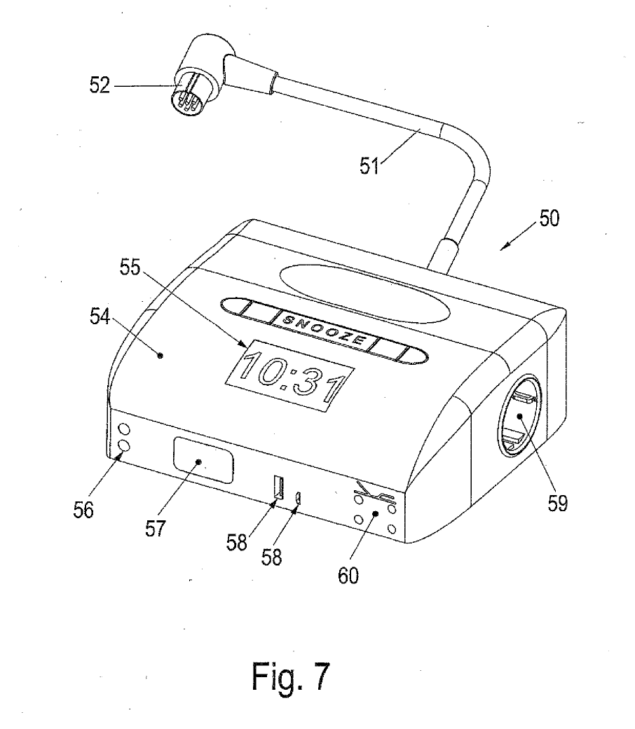

FIG. 7 shows a schematic perspective view of a multifunction radio device as a fourth exemplary embodiment of an auxiliary device.

FIG. 1 shows a furniture assembly having a piece of furniture 1. A bed is shown here as an example as the piece of furniture 1. The piece of furniture 1 has at least one support element 3 for accommodating objects, a cushion, a mattress M, and/or a person. The support element 3 is implemented, for example, as a slatted frame, as a level support surface, or the like and is attached on a base element 2, a framework having feet here, for coupling the piece of furniture 1 to a setup location, for example, a floor.

The support element 3 has here a back part 4 and a leg part 5, which are arranged movably mounted in relation to a further support element or in relation to the base part 2. This movable arrangement is implemented here by means of a so-called movement fitting 6. The movement is implemented as displaceable and/or pivotable.

The movably mounted back part 4 and the leg part 5 are each coupled to an electromotive adjustment drive 7, 8. The back part 4 is thus coupled to the electromotive adjustment drive 7. The electromotive adjustment drive 8 is provided for the movement or adjustment of the leg part 5.

The electromotive adjustment drives 7, 8 are implemented here as linear drives. The linear drives have one or a number of electric motors, wherein a speed-reducing gear having at least one gear step is connected downstream from each motor. A further gear, for example, in the form of a threaded spindle gear, which generates a linear movement of an output element from the rotational movement of the motor, can be connected downstream from the speed-reducing gear. The last gear element or a further element connected thereto forms the output element. The output element of the respective adjustment drive is connected to the respective movable furniture component (back part 4, leg part 5) or alternatively to a component connected to the base frame 2, so that during an operation of the electric motor of the respective adjustment drive 7, 8, the movable furniture components 4, 5 are adjusted in relation to one another or in relation to the base frame 2.

The electromotive adjustment drives 7, 8 are connected to a control unit 9. This connection can be embodied, for example, as a pluggable cable connection, which is not shown in greater detail here. The control unit 9 has an electrical supply unit, which provides the electrical energy, for example, from the network, for the electromotive adjustment drives 7, 8. For this purpose, the control unit 9 is connectable in this example via a network cable (not shown) having a network plug to a network terminal. The network plug conducts, via the network cable, the input-side network voltage to the electrical supply unit of the control unit 9, which outputs a low voltage in the form of a DC voltage on the secondary side and relays it to a motor controller.

Alternatively thereto, a network-dependent voltage supply (not shown in greater detail) having network input and having secondary-side low-voltage output, is connected upstream from the control unit 9, said voltage supply supplying the low voltage in the form of a DC voltage via the line 9d.

Furthermore, an operating unit 10, 10′ is assigned to the piece of furniture 1. Schematic perspective views of an operating unit 10, 10′ are shown in two different embodiments in FIGS. 2 and 2a. The operating unit 10, 10′ has operating elements 12, 13, by means of which the electromechanical adjustment drives 7, 8 are controllable via the control unit 9.

The operating unit 10 according to FIG. 2 is provided with a transmitting unit or transceiver unit for a wireless transmission. The wireless transmission can be a radio transmission link, optical transmission link (for example, infrared), and/or an ultrasound transmission link, wherein the control unit 9 is equipped with a respective corresponding receiving unit.

In another embodiment, the operating unit 10′ is implemented with an operating line 18 in wired form, as shown in FIG. 2a. In this case, the operating line 18 is connectable to the control unit 9, for example, pluggable.

The operating unit 10, 10′ is provided with operating elements 12, 13, which are provided for operating a respective electromotive adjustment drive 7, 8. The operating elements 12, 13 are embodied as buttons, for example. For example, the operating elements 12 are used for raising and the operating elements 13 are used for lowering the respective movable furniture part. FIGS. 2 and 2a show operating units 10, 10′ for six adjustment drives. In addition, auxiliary operating elements 16, 17 are provided, via which the auxiliary functions can be operable. Such auxiliary functions are explained in greater detail in conjunction with FIGS. 3 to 7. The auxiliary operating elements 15, 16, 17 can be embodied as buttons and/or switches.

Furthermore, the operating unit 10, 10′ is equipped with a signal element 14, for example, a light-emitting diode or a display unit. The signal element 14 is used, for example, for the function display or feedback, error display, etc.

A further auxiliary operating element 15, which can also consist of multiple operating elements and/or a combination operating element, is used for a so-called memory function of the electromotive adjustment drives 7, 8.

Upon actuation of an operating element 12, 13, a control signal for activating the respective electromechanical adjustment drive 7, 8 is transmitted wirelessly or in a wired manner to the control unit 9 via the transmission link. The control unit has switch elements, which convert the control signals of the transmission link into switching signals for switching the respective adjustment drive 7, 8. The switching elements can be, for example, relay switches and/or semiconductor switches. The manually operable operating elements 12, 13 of the operating unit 10 generate control signals, which are converted by the receiver of the control unit 9 into control currents for the switching elements. In the case of the wired operating unit 10′, the operating elements 12, 13 switch the control current of the relay switches or the semiconductor switches. In both cases, the power switches of the relay switches or the semiconductor switches switch the high motor current of the respective adjustment drive 7, 8.

FIG. 3 shows the control unit 9 having components connected thereto in greater detail in the form of a schematic block diagram. The assembly shown in FIG. 3 can be provided, for example, in the piece of furniture 1 of FIG. 1.

The control unit 9 has a supply terminal 90, which is implemented here as a network cable terminal. In an alternative embodiment, the supply terminal 90 can be implemented as a low-voltage terminal, which is connected via an external power supply unit, for example, a plug power supply unit, to the power network. The control unit 9 and also the adjustment drives 7, 8 are supplied with power via the power supply terminal 90. Furthermore, the power supply terminal 90 is used for the power supply of further components connected to the control unit 9, as explained in greater detail hereafter.

In addition to the power supply terminal 90, the control unit 9 has adjustment drive terminals 91, which are each connected to one of the adjustment units 7, 8. Electric motors arranged in the adjustment drives 7, 8 are activated directly and supplied with power via the adjustment drive terminals 91. In addition, a signal of an end switch arranged in the respective adjustment drive 7, 8 can be transmitted to the control unit 9 via the adjustment drive terminals 91. However, it can also be provided that the end switch signal is analyzed in the respective adjustment drive 7, 8. Furthermore, signal lines can be provided, via which a position of the output element of the adjustment drive 7, 8 is transmitted to the control unit 9, to take this position signal into consideration during the activation of the adjustment drives 7, 8.

Furthermore, an interface 92 is arranged on the control unit 9, via which the control unit 9 receives signals from the operating unit 10. As stated in conjunction with FIG. 1, the data transmission provided between the operating unit 10 and the control unit 9 can be performed in a wired or wireless manner via radio, optically (infrared), or via ultrasound.

In the exemplary embodiment shown in FIG. 3, a radio link is provided between the operating unit 10 and the control unit 9. Signals of the operating unit 10, which are transmitted from the operating unit 10 and relate to the actuation of the operating elements 12, 13, are converted by the control unit 9 into signals for the adjustment drives 7, 8. For this purpose, switching elements, for example, relays or semiconductor power switches, which switch a motor current for electric motors in the adjustment drives 7, 8, are provided in the control unit 9. A base functionality of the control unit 9 is thus provided by the output of power currents to the adjustment drive terminals 91.

To be able to assist flexible optional equipment features of a motorized piece of furniture 1, the control unit 9 according to the application has a multifunction terminal 93, on which a multifunction interface is provided. Auxiliary devices can be connected via the multifunction terminal 93, for example, in FIG. 3, a lighting unit 20 and an emergency lowering unit 30.

The lighting unit 20, which is also shown once again in a perspective view in FIG. 4, has a multifunction cable 21, on the free end of which a multifunction plug 22 is installed. This multifunction plug 22 can be plugged into the multifunction terminal 93 of the displacement unit. In addition, a further multifunction terminal 23, which is electrically connected to the multifunction cable 21, is arranged in the lighting unit 20. The multifunction terminal 23 is of the same type as the multifunction terminal 93 of the control unit 9. Terminal pins of the multifunction plug 22 of the lighting unit 20 are correspondingly daisy-chained on the multifunction terminal 23. The daisy-chaining of the connection is indicated in FIG. 3 by a dashed line between the multifunction terminal cable 21 and the multifunction terminal 23.

The multifunction interface applied to the multifunction terminals 93, 23 is a multi-pole interface, which comprises various line groups. On the one hand, at least two power supply lines, for example, one having a positive potential applied and one having ground potential, are provided. Components connected to the multifunction interface can be supplied with power via the power supply line. Furthermore, at least one data signal line is available, via which a preferably bidirectional serial data transmission can be performed. Instead of a signal data signal line, the potentials of which are acquired in relation to the shared ground line of the power supply lines in this meaning, a differential data signal transmission via two data signal lines is also possible. In general, known serial protocols such as RS232, RS485, or according to the USB (universal serial bus) standard can run on the data signal line or lines. A parallel data transmission can alternatively also be implemented.

In addition to the lines for power supply and for data transmission, signal lines are provided, at least one output line and one input line. The lines for signal transmission differ from those for data signal transmission in that they can transmit a single-pole digital switching signal. In this case, voltage is applied or is not applied to the output signal line by the control unit 9 in dependence on the actuation of specific ones of the operating elements 12, 13 or auxiliary operating elements 16, 17 on the operating unit 10. The output signal line is capable in this case by way of a switching element provided in the control unit of directly operating a load current of the order of magnitude of up to several hundred milliamps (mA), for example.

The at least one output line is provided according to the application for connecting an illuminant 21, for example, one or more LEDs (light-emitting diodes) of the lighting unit 20. Upon installation of the lighting unit 20 in the interior bed frame, an under bed light, which allows safe standing up out of the bed also at night, can thus be turned on by actuating a corresponding button on the operating unit 10. In addition, the illuminant 21 can be used as a signal light, in that specific operating states—for example, an error operating state—are signaled, for example, by a specific flashing rhythm of the illuminant 21.

Further output lines can be provided, for example, for the actuation of relays, using which network consumers can then be switched. Output lines can also be used for the selective power supply of components or parts of the components, for example, microcontrollers, connected to the multifunction interface.

In addition to the lighting unit 20, an emergency lowering unit 30 is connected to the control unit 9 as a further unit. The emergency lowering unit 30 is schematically shown in FIG. 5 in two different perspective views (partial figure a, partial figure b).

It has, like the lighting unit 20, a multifunction cable 31 having multifunction plug 32, and also a multifunction terminal 33 arranged in the housing. The emergency lowering unit 30 is plugged using its multifunction plug 32 into the multifunction terminal 23 of the lighting unit 20 in the exemplary embodiment of FIG. 3. The possibility is therefore made use of here of being able to connect multiple components in succession to the control unit 9, also if it only has one multifunction interface 93.

The emergency lowering unit 30 furthermore has an illuminant 34, which, like the illuminant 24 of the lighting unit 20, can function as a nightlight or also for status display. In addition, it has an emergency switch 35 embodied as a button, which acts directly on one of the lines in the multifunction cable 31 or 21 and is input by the control unit 9 as an input of the multifunction interface 93. Upon actuation of the emergency switch 35, the control unit 9 immediately instructs the adjustment drives 7, 8 to stop an upward movement. A possibly slowed downward movement is initiated simultaneously. The actuation of the emergency switch 35 has higher priority than contrary operating commands which are possibly output by the operating unit 10 and received by the radio interface 92.

As an additional safety measure, two receptacle shafts for emergency supply batteries 36, for example, in the form of commercially available 9 V blocks, are provided in the emergency lowering unit 30. The emergency supply batteries 36 are contacted via the battery clips 37. Upon actuation of the emergency switch 35, the battery voltage of the emergency supply batteries 36 is applied to a further line defined in the multifunction cable 31 or 21 and in the multifunction interface 93. It is thus ensured that also in the event of a failure of the power supply, sufficient energy for the control unit 9 for actuating the adjustment drives 7, 8 to lower the corresponding furniture part is available at the supply terminal 90 of the control unit 9. The energy of the emergency supply batteries 36 is typically sufficient at least for one lowering operation. However, the emergency supply batteries 36 are advantageously not continuously applied to the corresponding line of the multifunction interface 93, to prevent draining of the batteries by leakage currents, inter alia. The energy of the emergency supply batteries 36 is thus stored secured for an emergency in the event of actuation of the emergency switch 35.

Fastening holes 26 are provided for fastening the lighting unit 20, fastening tabs 38, also having corresponding holes for screws, are provided for fastening the emergency lowering unit 30. Other fastening possibilities, for example, sticking on via double-sided adhesive tape on a frame of the piece of furniture 1, are also conceivable.

FIG. 6 shows a further auxiliary device connectable to the multifunction terminal 93. In this case, this is a USB (universal serial bus) unit 40, which can also be connected via a multifunction cable 41 having multifunction plug 42 directly to the multifunction terminal 93 of the control unit 9 or to a multifunction terminal 23, 33 provided by another auxiliary device.

The USB unit 40 provides one or more, two USB terminals 44 here, for example, which can be used in a simplest embodiment of the USB unit 40 as charging sockets for connected USB devices, for example, smart phones or tablets. In an expanded embodiment of the USB unit 40, data lines of the USB terminals 44 are also actively usable and are switched to the data signal lines of the multifunctional interface, optionally after a protocol adaptation. In such an embodiment, for example, a USB memory stick can be connected to one of the USB terminals 44, wherein an update of operating software of the control unit is loaded via this USB memory stick, for example.

Furthermore, the USB unit 40 can optionally function as an audio interface. For this purpose, audio terminals 35, for example, 3.5 mm jacks, are provided, which are connected to an audio cable 46. The audio cable 46 has, on its free end, audio terminals, for example, also jack plugs, which are pluggable into an audio system installed under the bed.

For the fastening, the USB unit 40 has a depressed surface below the terminals 44, 45. The USB unit 40 can thus be inserted in a simple manner between mattress and bed frame, wherein it is fixed by the mattress and the terminals 44, 45 are easily externally accessible. Alternatively, the USB unit 40 having the depressed surface 47 can also be fixed on the bed frame with the aid of double-sided adhesive tape. Magnetic fastening is also possible and suggests itself in particular in the case of bed frames or slatted frames made of iron or steel.

FIG. 7 shows a multifunction radio device 50 also suitable for connection to the control unit 93. A connection to the multifunction interface is again possible via a multifunction cable 51 having attached multifunction plug 52. The multifunction radio device 50 can be implemented as a terminal, i.e., it does not provide a further multifunction interface for connecting further components. Alternatively, it is possible to also arrange a multifunction interface (not shown in FIG. 7) on the multifunction radio device 50.

The multifunction radio device 50 has a radio part 54 and a clock part 55, which preferably cooperate as a radio alarm clock. Furthermore, sensors 56 can be provided, for example, a brightness sensor for setting the brightness of the display of the clock 55 and/or a movement detector, which automatically turns on a background light of operating elements of the multifunction radio device 50 when a movement of a user is detected. Furthermore, it can be provided that a registered movement of a user is relayed as a corresponding signal to the multifunction interface. Thus, for example, a lighting unit, for example, the lighting unit 20, can be turned on.

Furthermore, a light or lamp 57 can be provided, which can be turned on both as a reading lamp at the multifunction radio device 50 and can also be turned on by a corresponding command of the operating unit 10, like the illuminants 24 and 34, via the corresponding line of the multifunction interface 93. Furthermore, USB terminals 58 can also be provided here, with regard to the function of which reference is made to the USB unit of FIG. 6. Furthermore, a network power socket 59 is provided, which provides a switched network voltage to switch further devices in dependence on the clock 55 and/or in dependence on commands received via the multifunction cable 51 on its data signal lines with the aid of the operating unit 10 by the control unit 9. Thus, for example, larger lighting units, inter alfa, can also be switched from the bed using the one operating unit 10. The multifunction radio device 50 can be supplied with power via the power supply lines of the multifunction cable 51, with the exception of the network power socket 59. If this is provided, an additional network cable is required for the multifunction radio device 50. Such a switched network power socket can also be provided by a correspondingly implemented separate auxiliary device.

Finally, the multifunction radio device 50 optionally has operating elements 60, using which a control of the control unit 9 and the adjustment drives 7, 8 can be performed, in addition to the operating unit 10. Corresponding control commands are transmitted via the data signal lines of the multifunction cable 51. An emergency switch, which corresponds in its function to the emergency switch 35 of the emergency lowering unit 30, can also be provided in the multifunction radio device 50. One or more batteries for the emergency supply, corresponding to the battery 36 of the emergency lowering unit 30, can also be arranged in the multifunction radio device 50.

In the illustrated or alternative further auxiliary devices, a Bluetooth interface can additionally be provided, for example, to couple a smart phone, for the purpose of data exchange or for operation of the piece of furniture 1, to the data signal lines of the multifunction terminal.

In a further embodiment of the system, it is provided that a further control unit for adjustment drives, which are on the piece of furniture 1 or a further piece of furniture, for example, a second part of a double bed, is arranged, via which the multifunction interface is connected to the control unit 9. Data and/or signals exchanged via the multifunction interface can be used to synchronize the further control unit with the control unit 9, so that, for example, synchronized movements of furniture parts can be performed.

### LIST OF REFERENCE SIGNS

1 piece of furniture
2 base element
3 support element
4 back part
5 leg part
6 movement fitting
7, 8 adjustment drive
9 control unit
10 operating unit
11 housing
12, 13 operating element
14 signal element
15, 16, 17 auxiliary operating element
18 operating line
20 lighting unit
21 multifunction cable
22 multifunction plug
23 multifunction terminal
24 illuminant
25 near field radio interface
26 fastening holes
30 emergency lowering unit
31 multifunction cable
32 multifunction plug
33 multifunction terminal
34 illuminant
35 emergency switch
36 emergency supply battery
37 battery clips
38 fastening tabs
40 USB unit
41 multifunction cable
42 multifunction plug
44 USB terminal
45 audio terminal
46 audio cable
47 fastening surface
50 multifunction radio device
51 multifunction cable
52 multifunction plug
54 radio
55 clock
56 sensor
57 light/lamp
58 USB terminal
59 network power socket
60 operating elements
90 supply terminal
91 adjustment drive terminal
92 radio interface
93 multifunction terminal
M mattress

1-18. (canceled)

19. A control unit for at least one electromotive adjustment drive of a piece of furniture, said control unit comprising:
at least one adjustment drive terminal for connection to the at least one electromotive adjustment drive;
an interface for coupling to at least one operating unit, wherein, upon actuation of an operating element of the operating unit, a switching signal is output at the terminal to activate the at least one electromotive adjustment drive or an electric motor of the electromotive adjustment drive; and
a multifunction terminal implemented as a multifunction interface, which has at least one data signal line for data transmission, at least one power supply line, and at least one input signal line and one output signal line,
wherein the control unit is configured for outputting data signals on the data signal line of the multifunction interface in dependence on an actuation of one of the operating elements or further operating elements of the operating unit.

20. The control unit of claim 19, wherein the control unit is configured to apply voltage to the at least one output signal line in dependence on an actuation of one of the operating elements or further operating elements of the operating unit.

21. The control unit of claim 19, wherein at least one output signal line is configured to activate an illuminant.

22. The control unit of claim 19, wherein the control unit is configured to input and analyze a signal on the at least one input signal line.

23. The control unit of claim 22, wherein the signal on the at least one input signal line relates to emergency lowering of the at least one adjustment drive, said control unit being configured to actuate the at least one adjustment drive independently of an actuation of an operating element of the operating unit.

24. The control unit of claim 19, wherein the multifunction terminal has an emergency power supply line in addition to the power supply line.

25. An auxiliary device, comprising a multifunction cable having multifunction plugs for connection to a multifunction terminal of a control unit for at least one electromotive adjustment drive of a piece of furniture so as to render a multifunction interface of the control unit available in the auxiliary device.

26. The auxiliary device of claim 25, further comprising a multifunction terminal which is electrically connected to the multifunction cable.

27. The auxiliary device of claim 25, implemented as a lighting unit having an illuminant, which is supplied with power and/or activated via one of the output signal lines of the multifunction interface.

28. The auxiliary device of claim 25, implemented as an emergency lowering unit having an emergency switch configured to interact with one of the input signal lines of the multifunction interface.

29. The auxiliary device of claim 28, further comprising a battery receptacle adapted for receiving at least one battery for applying a voltage to an emergency power supply line of the multifunction interface upon actuation of the emergency switch.

30. The auxiliary device of claim 25, implemented as a USB terminal unit having at least one USB46 terminal, which is connected to power supply lines and/or data signal lines of the multifunction interface.

31. The auxiliary device of claim 30, further comprising an audio terminal operatively connected to the USB terminal unit for relaying an audio signal via an audio cable.

32. The auxiliary device of claim 25, implemented as a multifunction radio device having a radio.

33. The auxiliary device of claim 32, wherein the multifunction radio device has a clock.

34. The auxiliary device of claim 25, further comprising a network power socket, which is switchable via data signals on the data signal line of the multifunction interface.

35. A system for controlling at least one adjustment drive of a piece of furniture, comprising:
a control unit including at least one adjustment drive terminal for connection to the at least one electromotive adjustment drive, an interface for coupling to at least one operating unit, wherein, upon actuation of an operating element of the operating unit, a switching signal is output at the terminal to activate the at least one electromotive adjustment drive or an electric motor of the electromotive adjustment drive, and a multifunction terminal implemented as a multifunction interface, which has at least one data signal line for data transmission, at least one power supply line, and at least one input signal line and one output signal line, wherein the control unit is configured for outputting data signals on the data signal line of the multifunction interface in dependence on an actuation of one of the operating elements or further operating elements of the operating unit; and
at least one auxiliary device including a multifunction cable having multifunction plugs for connection to a multifunction terminal of the control unit so as to render the multifunction interface of the control unit available in the auxiliary device.

36. A piece of furniture, comprising:
a frame element;
at least one adjustment drive an;
a support element guided movably in the frame element via the at least one adjustment drive; and
a system for controlling the at least one adjustment drive, said system comprising a control unit including at least one adjustment drive terminal for connection to the at least one electromotive adjustment drive, an interface for coupling to at least one operating unit, wherein, upon actuation of an operating element of the operating unit, a switching signal is output at the terminal to activate the at least one electromotive adjustment drive or an electric motor of the electromotive adjustment drive, and a multifunction terminal implemented as a multifunction interface, which has at least one data signal line for data transmission, at least one power supply line, and at least one input signal line and one output signal line, wherein the control unit is configured for outputting data signals on the data signal line of the multifunction interface in dependence on an actuation of one of the operating elements or further operating elements of the operating unit, and at least one auxiliary device including a multifunction cable having multifunction plugs for connection to a multifunction terminal of the control unit so as to render the multifunction interface of the control unit available in the auxiliary device.
